(19) United States
(12) Patent Application Publication
(10) Pub. No.: US 2026/0122573 A1
(43) Pub. Date: Apr. 30, 2026

(54) SMALL DATA TRANSMISSION POWER OPTIMIZATIONS

(71) Applicant: QUALCOMM Incorporated, San Diego, CA (US)

(72) Inventors: Sai Laxman SAMBARAJU, Hyderabad (IN); Raghuveer Ramakrishna Srinivas TARIMALA, Hyderabad (IN); Nazmul ISLAM, Littleton, MA (US); Shat PRATEEK, Agra (IN)

(21) Appl. No.: 19/017,246

(22) Filed: Jan. 10, 2025

Related U.S. Application Data
(63) Continuation of application No. 18/927,685, filed on Oct. 25, 2024.

(51) Int. Cl. H04W 52/02; H04W 72/232; H04W 76/27; H04W 76/28

(52) U.S. Cl. CPC H04W 52/0235; H04W 72/232; H04W 76/27; H04W 76/28

(57) ABSTRACT

Certain aspects of the present disclosure provide techniques for a UE to perform a small data transmission (SDT) during an SDT session; and enter a low power state, subsequent to the SDT, during the SDT session. Certain aspects provide for a network entity (NE) to send at least one of an SDT termination command, an indication of an SDT-specific DRX cycle, or an implicit SDT release timer; and perform SDT during an SDT session.

### INTRODUCTION

This Application is a continuation under 35 U.S.C. § 120 of U.S. patent application Ser. No. 18/927,685, filed on Oct. 25, 2024, which is assigned to the assignee of the present application and hereby expressly incorporated by reference herein in its entirety.

### FIELD OF THE DISCLOSURE

Aspects of the present disclosure relate to wireless communications, and more particularly, to techniques for power optimizations for small data transmission (SDT) in radio resource control (RRC) inactive states.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes performing an SDT during an SDT session; and entering a low power state, subsequent to the SDT, during the SDT session.

Certain aspects provide a method for wireless communications by a UE. The method includes obtaining at least one of a SDT termination command, or an implicit SDT release timer; and entering a discontinuous reception (DRX) state in association with an end of an SDT session.

Certain aspects provide a method for wireless communications by a network entity (NE). The method includes sending at least one of a SDT termination command, an indication of an SDT-specific DRX cycle, or an implicit SDT release timer; and performing SDT during an SDT session.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of periodic small data transmission (SDT) sessions.

FIG. 6 depicts an example of a power optimized SDT session.

FIG. 7 depicts a process flow for communications in a network between a UE and a network entity (NE) for power optimized SDT.

FIG. 8 depicts a second process flow for communications in a network between a UE and NE for power optimized SDT.

FIG. 9 depicts a third process flow for communications in a network between a UE and NE for power optimized SDT.

FIG. 10 depicts a method for wireless communications.

FIG. 11 depicts a method for wireless communications.

FIG. 12 depicts another method for wireless communications.

FIG. 13 depicts another method for wireless communications.

FIG. 14 depicts aspects of an example communications device.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for power optimizations for SDT in RRC inactive state.

Telecommunications technologies such as Fifth Generation New Radio (5G NR, or simply 5G) or Sixth Generation (6G) may allow a user equipment (UE) to be in one of multiple states to reduce energy consumption, delays, and consumption of compute resources. For example, a UE may enter into a radio resource control (RRC) idle state (RRC_IDLE, or simply RRC idle), an RRC connected state (RRC_CONNECTED, or simply RRC connected), or an RRC inactive state (RRC_INACTIVE, or simply RRC inactive), and may transition between these different states. For example, after completion of a burst transmission, a UE may enter an RRC idle or RRC inactive state. The RRC connected state may be a state where the UE may communicate directly with the network for data transfer and signaling via an active connection. For example, in periods of consistent or high throughputs, a UE may enter an RRC connected state. This state may support application data exchange and network control tasks such as handovers.

The RRC idle state may be a low-activity state designed to conserve battery life and manage UE mobility without active communication. In this state, the UE may not be actively engaged in data transfer but may still receive system information and paging messages. The RRC inactive state may be an intermediate state between the RRC connected state and the RRC idle state, and may balance battery efficiency and quick resumption of activity. The RRC inactive state may allow the UE to enter sleep mode and conserve battery life. This state may enable the UE to suspend its connection while remaining registered with the network, which may allow rapid reactivation. Therefore, the RRC inactive state may allow a faster transition to RRC connected state compared to the RRC idle state, because in RRC inactive state a UE context may be maintained by both the network and the UE, allowing the core network connection to be maintained.

The UE in the RRC inactive state may undertake small data transmissions (SDT), which may allow the UE to transmit data while it remains in the RRC inactive state without having to switch to the RRC connected state. “SDT” refers to transmission of small amounts of data by the UE without the need to establish a full data connection. Traditionally, a UE would need to transition to the RRC connected state, which involves a signaling procedure, to send data. This transitioning process to the RRC connected state may include resource overhead (compute or signaling resources) making it inefficient for small data transmissions. SDT in the RRC inactive state therefore allows data to be sent while the UE remains in the RRC inactive state, reducing the need for extensive signaling and thus saving power and improving efficiency.

Messaging with social media applications, direct messaging applications, and text messages over telecommunications networks are use case examples of burst transmissions or low throughputs, for which SDT may be suitable. A burst transmission is the broadcast of a relatively high-bandwidth transmission over a short period where there are intermittent periods of high throughput that may be followed by periods of no to low throughput. Throughput refers to a data transfer rate in a telecommunications network. For example, a low throughput refers to reduced amount of data traveling and processing between a network entity (NE) and other NEs in a telecommunication network.

SDT may be useful for a UE with regular payloads of data that are relatively small compared to the control signal(s) required to transition to the RRC connected state. For example, SDT may be particularly useful for IoT devices that frequently send small data packets, since SDT may reduce signaling overhead and power consumption at these IoT devices. Therefore, SDT may be particularly useful for low throughput and burst transmission use cases.

There are various mechanisms to support SDT in the RRC inactive state. A first mechanism is based on a random access channel (RACH) procedure where a payload is transmitted during a random-access procedure. A second mechanism supports SDT by using preconfigured grant-based physical uplink shared channel (PUSCH) resources. These PUSCH resources are configured with parameters including resource blocks, periodicity, time offset, and modulation and coding scheme (MCS), or other parameters, and are configured for the UE during its RRC connected state. This allows the UE to transition to the RRC inactive state and utilize the configuration parameters. The UE therefore utilizes the aforementioned PUSCH resources for communications during SDT.

A UE may perform SDT within an SDT session when the UE is in an RRC inactive state. However, an SDT session may involve operations that consume some amount of power, such as a standby state portion, where the UE remains awake to perform PDCCH decoding after the SDT. For example, the UE may remain awake and decode signals from the NE until the UE receives a release command from the NE to end the SDT session. SDT sessions may have a maximum time limit configured by an NE. However, when the SDT session time limit is observed, then an SDT session is likely to be less efficient since the UE is in an awakened state (e.g., when performing PDCCH decoding) for the remainder of the SDT session subsequent to completion of SDT.

For example, an SDT session timer (e.g., a T319a timer) may govern the length of an SDT session, and may have a duration between one hundred milliseconds and four seconds. Meanwhile, SDT is usually configured for a duration of less than one second. Therefore, in certain instances, a UE completes SDT and completes all data transfers, yet nonetheless remains in an awakened state in the SDT session undertaking PDCCH decoding to await a release signal from the NE to end the SDT session. In this awakened state, the UE may consume more power than the UE would otherwise consume in a non-SDT state, rendering SDT sessions less efficient than comparable communication methods, e.g., communications in a connected-mode discontinuous reception mode.

SDT will reduce total power consumption or the rate of power consumption only when it is terminated quickly by the NE (in the order of few tens of ms) after completion of SDT. But this is not practically achievable in networks due to the length of the T319a timer that exceeds the duration of the SDT and determines the length of the SDT session. Early termination is also not practically achievable due to the lack of a protocol for the UE to know when to terminate the SDT session, and the NE considering worst case latency scenarios (e.g., backhaul latency) in determining release of SDT which may elongate the SDT release timer.

Furthermore, early termination of an SDT session may be uncommon due to the lack of motivation for an NE to release an SDT early. Under legacy approaches, there is no motivation for an NE to release the SDT earlier than its initial configuration. On the contrary, aggressively releasing an SDT may increase a paging load. Paging is a procedure in 5G for an NE to manage and deliver data to UEs efficiently. For example, a paging procedure may notify a UE that the NE has data waiting for it. Releasing an SDT session early may therefore increase the number of paging messages and increase resource use by the NE increasing resource load on the NE, UE, or both. This means that an SDT that is not terminated early, and the UE generally completes SDT and remains in an SDT session for the full duration of the T319a timer. The SDT session may then remain inefficient in terms of power consumption since the SDT session is longer than is necessary for completion of SDT.

Aspects described herein provide enhancement of SDT by introducing power optimizations to SDT sessions to reduce their power consumption. In some aspects, a UE may perform an SDT during an SDT session; and enter a low power state, subsequent to the SDT, during the SDT session. The low power state reduces power consumption during the SDT session and takes the UE from a standby state (where it is in an awakened state to monitor or decode PDCCH) to a low power state.

The technical benefit provided by the SDT power optimizations described herein include reducing UE power consumption during an SDT session. This reduces UE power consumption during SDT sessions and allows SDT sessions to be more attractive to UEs and to networks, as a viable option for communication, increasing their use to a broader range of contexts due to the power efficiencies they provide.

Another advantage of SDT power optimizations is that the power savings are UE based and not dependent on the NE. The UE will be able to benefit from power savings locally due to optimal implementation of SDT power optimizations by the UE. The UE does not have to rely on external dependencies, allowing it to better fine tune its power states in SDT sessions and control its power consumption in different contexts.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

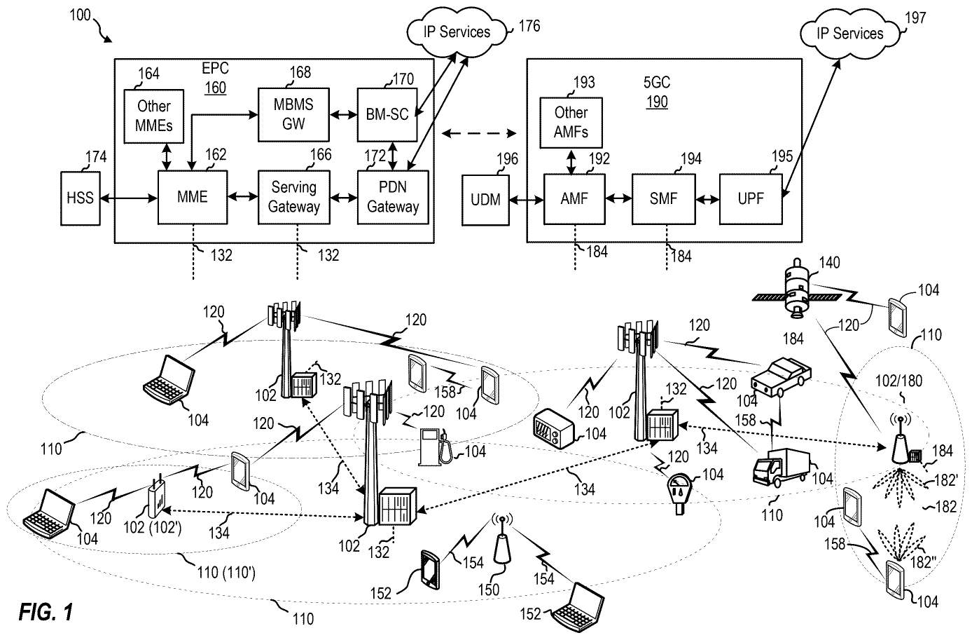

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

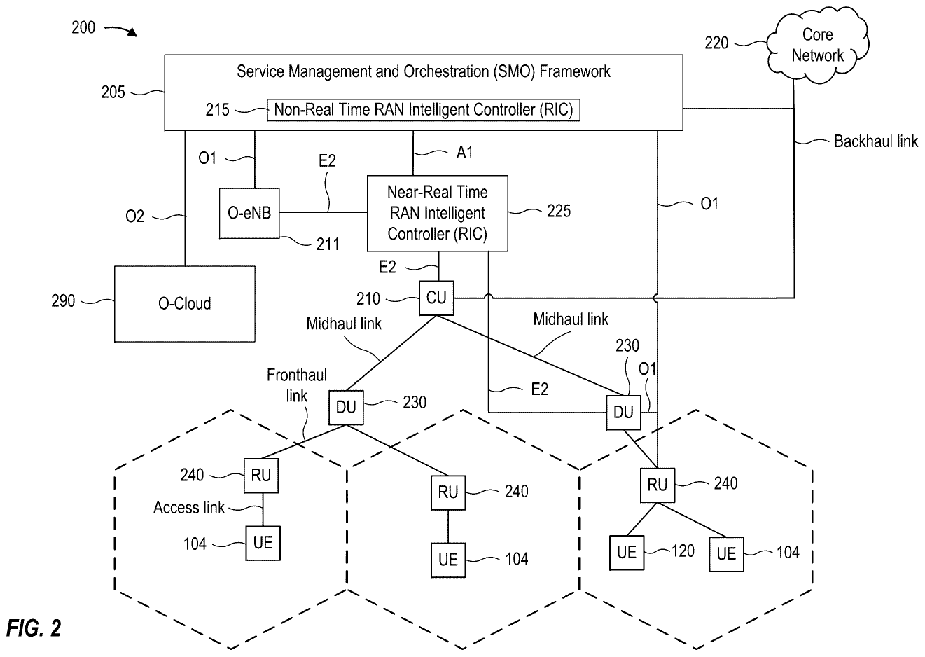

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

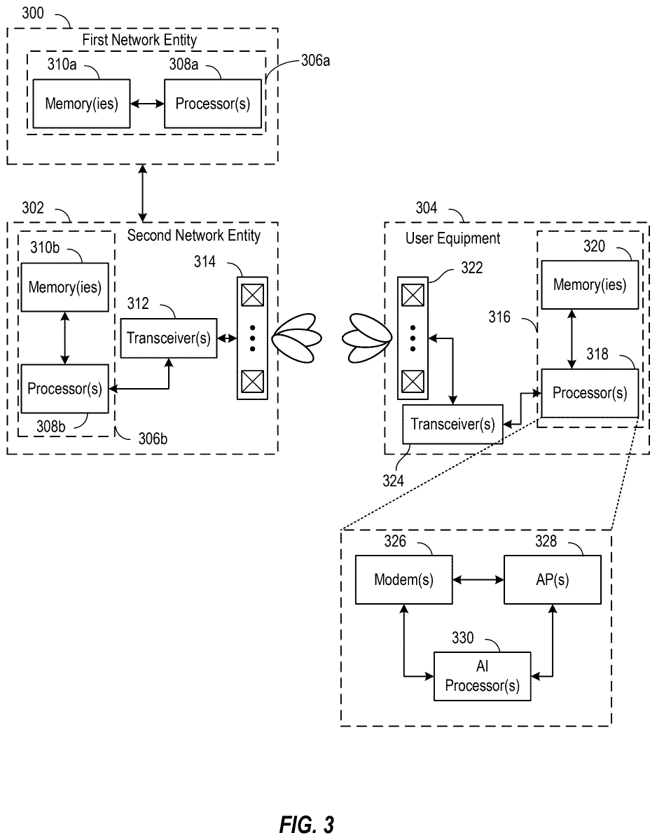

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

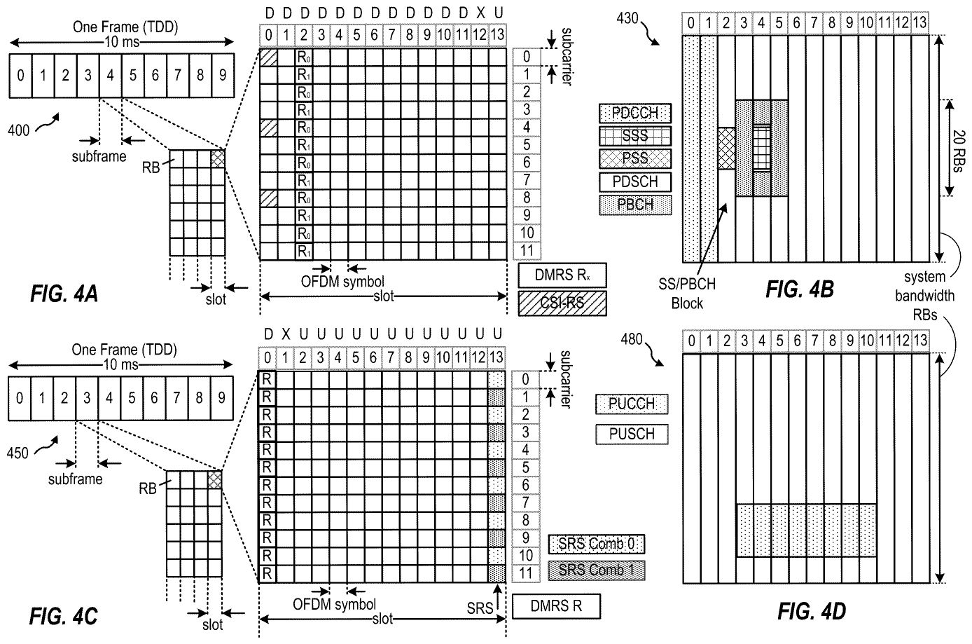

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to SDT

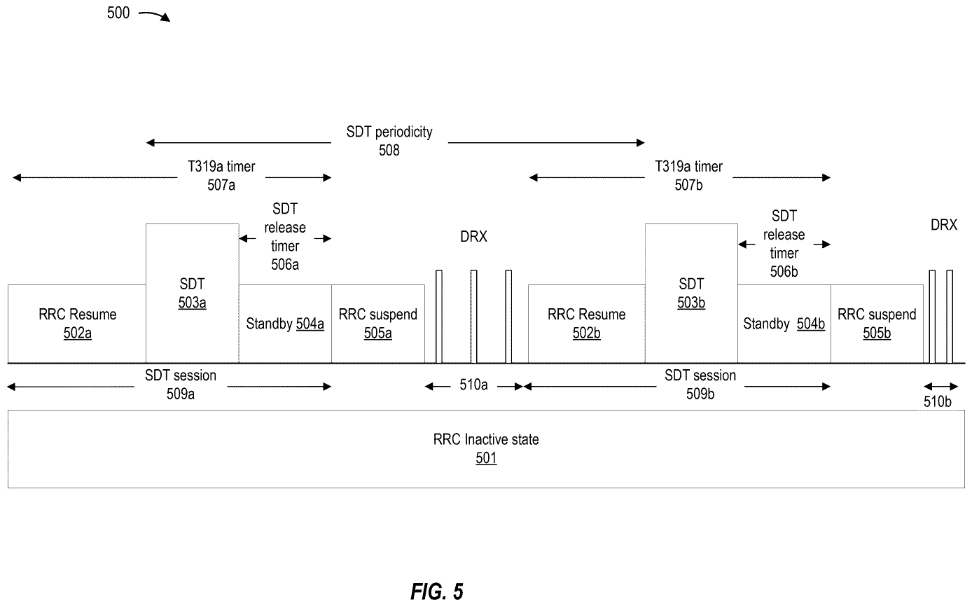

FIG. 5 depicts an example 500 of periodic SDT sessions.

The operations of FIG. 5 may be performed by a UE and a network entity. In some aspects, a network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3. However, in other aspects, UE may be another type of wireless communications device and NE may be another type of network entity or network node, such as those described herein.

Example 500 comprises periodic SDTs 503a and 503b, separated by SDT periodicity 508. SDTs 503a and 503b are within SDT sessions 509a and 509b, respectively. The SDT session 509a may span a duration of a T319a timer 507a, while the SDT session 509b may span a duration of a T319a timer 507b. Therefore, in some aspects, the T319a timer 507a defines the maximum duration of the SDT session 509a. Meanwhile the T319a timer 507b defines the maximum duration of the SDT session 509b. In some aspects, the T319a timers 507a and 507b are configured by the NE.

SDT sessions 509a and 509b are RRC inactive state operations and therefore occur when the UE is in RRC inactive state 501. Within each SDT session 509a and 509b there may be an RRC connection resume operation (RRC resume) 502a and 502b, respectively. The RRC resume 502a and 502b that re-establishes a previously suspended RRC connection between the UE and the NE.

Subsequent to the RRC resume 502a, SDT 503a may occur between the UE and NE. For example, the SDT 503a may comprise data transfer via a RACH message, a configured grant PUSCH, or the like. Subsequent to the SDT 503a, e.g., when the SDT 503a is completed, the UE enters a standby state 504a where it performs PDCCH decoding. In the standby state 504a, the UE remains awake for a duration defined by the SDT release timer 506a (which may be configured by the NE) to monitor, receive, and decode PDCCH signals from the NE.

During the standby state 504a, the UE may monitor PDCCHs until an RRC release command with a suspend configuration (to keep the UE in RRC inactive state 501) for an RRC suspend operation 505a is received by the UE, or the SDT release timer 506a expires. The receiving of the RRC release command for the RRC suspend operation 505a or the expiration of the SDT release timer 506a triggers the UE to commence the RRC suspend operation 505a. In some aspects, the SDT release timer 506a commences from the end of the SDT 503a, and may set a maximum allowable time for a UE to be in standby 504a without performing another SDT 503a.

Therefore, during the standby state 504a, the UE may be inefficiently using power, even though it is still operating within the SDT session 509a. This is because the UE is kept awake to monitor and receive PDCCH signals from the NE, and perform decoding of the PDCCH that inform it either of another SDT or an RRC release command (with a suspend configuration) to suspend the SDT session 509a to keep it in RRC inactive state 501. Once the UE receives the RRC release command (that may include a suspend configuration) from the NE, then it may enter RRC suspend 505a and exit the SDT session 509a. “RRC suspend 505a” refers to a procedure by which an established RRC connection between a UE and NE is terminated.

In some aspects, the SDT session 509a is terminated upon the end of the T319a timer 507a. At the end of the T319a timer 507a, in some aspects, the UE may enter an RRC idle state upon receiving the RRC release command. In some aspects, upon the end of the RRC suspend 505, the UE enters a discontinuous reception (DRX) cycle 510a while within the RRC inactive state 501. The DRX cycle 510a may be an inactive mode DRX cycle. The DRX cycle 510a is a power saving feature that allows the UE to switch periodically between an on-duration (active state) and off-duration (an inactive state). In a DRX cycle, the UE preserves its battery by spending most of its time in the off-duration in which it cannot be scheduled. For example, the UE may not monitor for paging or a PDCCH in the off-duration. In the on-duration, the UE in a DRX cycle may monitor for messages such as paging messages and/or may be scheduled. Subsequent to the DRX cycle 510a, the UE may enter another SDT session 509b via the RRC resume 502b to conduct the SDT 503b, with timing based on the SDT periodicity 508 that defines the duration between the SDT 503a and 503b.

### Aspects Related to Power Optimizations for SDT

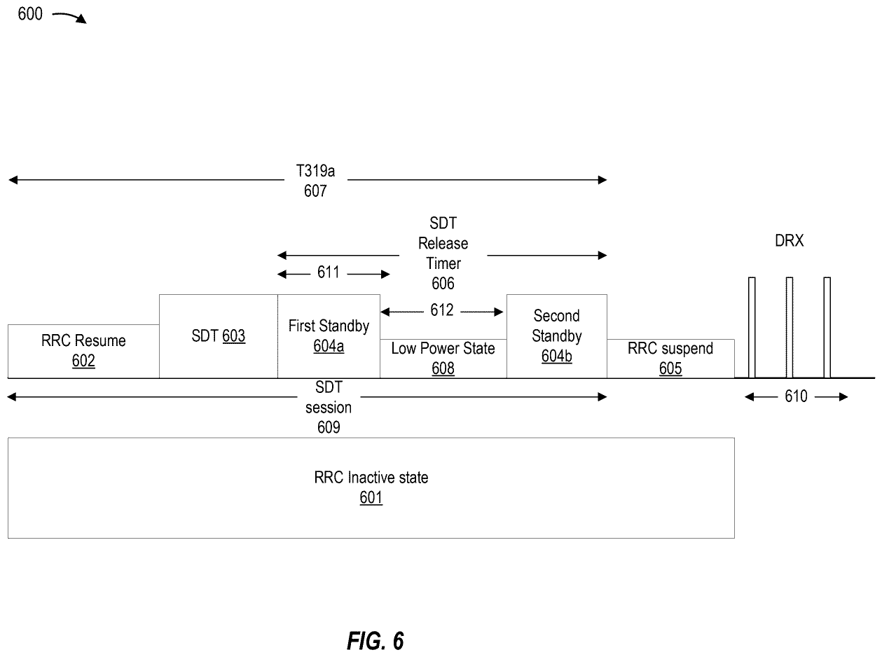

FIG. 6 depicts an example of a power optimized SDT session.

The operations of FIG. 6 may be performed by a UE and a network entity. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3. However, in other aspects, UE may be another type of wireless communications device and NE may be another type of network entity or network node, such as those described herein.

Example 600 comprises an RRC resume 602 that may trigger commencement of a power optimized SDT session 609. The power optimized SDT session 609 may occur while the UE is in an RRC inactive state 601. The RRC resume 602 may correspond to the RRC resume 502 of FIG. 5. The maximum duration of the SDT session 609 may be determined by a T319a timer 607. For example, the T319a timer 607 may correspond to the T319a timers 507a or 507b of FIG. 5. Once the SDT session 609 commences after the RRC resume 602, an SDT 603 may be performed by the UE. For example, the SDT 603 may correspond to the SDT 503 of FIG. 5.

In the example 600 of the power optimized SDT session 609, the UE may enter a first standby state 604a subsequent to an end of the SDT 603. The first standby state 604a or the second standby state 604b (collectively standby state(s)), may be similar to the standby states 504a or 504b of FIG. 5. For example, in the first standby state 604a (individually or in combination with the second standby state 604b), the UE may perform PDCCH decoding of signals received from the NE. The UE may remain in an awake state for a maximum duration defined by the SDT release timer 606 (which may be configured by the NE) to monitor, receive, and decode PDCCH signals from the NE. The SDT release timer 606 may correspond to the SDT release timer 506 of FIG. 5.

During the standby states 604a, 604b, the UE may decode PDCCH until the UE receives an RRC release command to suspend the UE with an RRC suspend operation 605 (RRC suspend 605), or the SDT release timer 606 expires. The receiving of the RRC release command for the RRC suspend 605 or the expiration of the SDT release timer 606 trigger the UE to commence the RRC suspend 605. In some aspects, the SDT release timer 606 commences from the end of the last SDT. The SDT timer 606 sets a maximum time for a UE to be in the standby states 604a and 604b without performing another SDT 603. “RRC suspend 605” refers to a procedure by which an established RRC connection between a UE and NE is terminated

During the standby states 604a and 604b, the UE uses power because the UE is kept awake to monitor and receive PDCCH signals from the NE, and perform decoding of the PDCCH that inform it either of another SDT or of an RRC release command with a suspend configuration (to keep the UE in RRC inactive state 501) and to suspend the SDT session 609 with the commencement of the RRC suspend 605. In the example 600 of the power optimized SDT session 609, the standby state 604a may last for a first standby duration 611 and then enter a low power state 608 for a low power duration 612 after the end of the first standby duration 611. After the low power duration 612, the UE may enter the standby state 604b. Examples of the low power state 608 are provided elsewhere herein.

In some aspects, the first standby duration 611 that determines the length of the first standby state 604a may be based on historical tracked data. For example, the historical tracked data may be obtained during tracking procedures performed by the UE. The tracking procedures may have been performed by the UE during other first standby states 604a in previous SDT sessions). In some aspects, the first standby duration 611 may be based on data obtained through a machine learning model trained on historical data related to SDT, or from other UEs. In some aspects, the first standby duration 611 is associated with at least one of historical temporal data or a release timer associated with an NE. “Historical temporal data” may refer to data related to timings and durations of SDT, SDT sessions, and/or various operations associated with them. This historical temporal data may be collected by the UE, or obtained from other UEs or data sources. The release timer is a timer that is defined by the NE to release the UE from one state to another, e.g., from the first standby state 604a to the low power state 608. For example, the first standby duration 611 may be based on predefined data associated with, or retrieved from, the NE. For example, the predefined data may include an NE SDT configuration that defines a length of the SDT 603. In some aspects, the UE may set the first standby duration 611.

In some aspects, the UE may set the low power duration 612. For example, the low power duration 612 may be based on historical tracked data (e.g., historical data on timing of when an RRC release command is sent to the UE in SDT sessions). In some aspects, the low power duration 612 may be based on a configuration associated with the NE. For example, the NE may have a pre-configured timing of when to send the RRC release command, e.g., three seconds after the end of the SDT 603. This configuration may be known to the UE which it may use to set the low power duration 612.

In some aspects, the first standby state 604a may be used to track the SDT session 609, a duration of the SDT 603, or the SDT release timer 606 to collect data. The UE may determine the first standby duration 611 or the low power duration 612 of the SDT session 609 based on this data. For example, in some aspects, the UE may use a formula to determine the low power duration 612:

$$\begin{matrix}Maximum low power duration 612 = start time of of RRC suspend 605 - end time of the \\ SDT 603\end{matrix}$$

For example, if the time of the RRC suspend 605 commences at 4 seconds from the start of the SDT session 609 (e.g., an expected time of a start of the RRC suspend 605 based on historical data), and the SDT 603 has been ongoing for 1.5 seconds, e.g., it is at 1.5 seconds, then a possible low power duration 612 for a low power state 608 may last 2.5 seconds (i.e., 4 seconds-1.5=2.5 seconds maximum available duration, assuming that the 1.5 seconds is the end of the SDT 603). Therefore, the maximum low power duration 612 for this equation includes any duration available and which may be used by the first standby 604a or the second standby 604b. In some aspects, the UE may have available to it a known (e.g., provided by the NE) or expected timing (e.g., based on historical data) of when the RRC release command will be sent by the NE which it may use to determine the start of the RRC suspend 605 and the end of low power state 608 and its duration 612.

Therefore, to improve the power consumption efficiency of the SDT session 609, the example 600 presents the low power state 608 that the UE may enter into after the first standby state 604a, for a low power duration 612. The UE may exit the low power state 608 after the end of the low power duration 612 and enter a second standby state 604b. For example the low power state 608 may include the UE entering a sleep mode to reduce power consumption. Other examples of the low power state 608 are described elsewhere herein.

The UE enters the second standby state 604b, during which the UE may receive an RRC release command (that may include a suspend configuration) from the NE. The UE may then perform an RRC suspend 605. The RRC suspend 605 refers to a procedure by which an established RRC connection between a UE and NE is terminated, to cause the UE to exit the SDT session 609. In some aspects, the UE may exit the SDT session 609 and enter a DRX cycle 610 of the RRC inactive state 601. In some aspects, the UE may exit the SDT session 609 and enter a DRX cycle 610 of an RRC idle state. The DRX cycle 610 may correspond to the DRX cycle 510 of FIG. 5.

### Example Signaling of Power Optimizations for SDT in RRC Inactive State

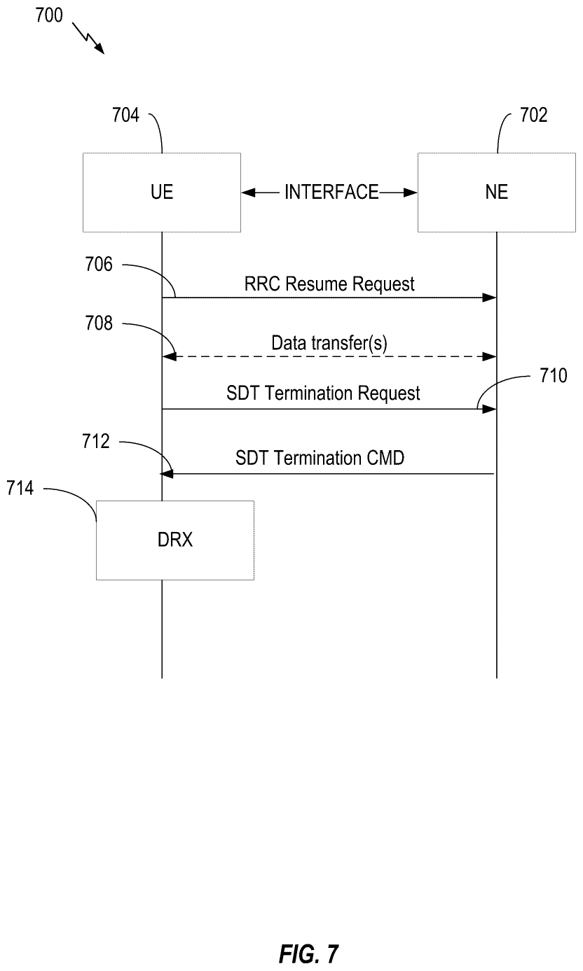

FIG. 7 depicts a process flow 700 for communications in a network between a UE 704 and an NE 702 for power optimized SDT. The process flow 700 may include blocks 706-714.

In some aspects, a network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, the UE 704 may be another type of wireless communications device and NE may be another type of network entity or network node, such as those described herein.

In some aspects, the process flow 700 begins at 706 with the UE 704 sending and the NE 702 receiving an RRC resume request. Based on the RRC resume request, the UE 704 may enter an RRC resume operation that corresponds to the RRC resume 502 of FIG. 5 or the RRC resume 602 of FIG. 6. For example, the UE 704 may establish a connection with the NE 702, where the UE 704 enters an SDT session that may correspond to the SDT session 509 of FIG. 5 or the SDT session 609 of FIG. 6.

The process flow 700 then includes data transfer at 708 between the UE 704 and the NE 702. The data transfer at 708 may be SDT, and may correspond to SDT 503 of FIG. 5 or SDT 603 of FIG. 6. The data transfer at 708 may be from the UE 704 to the NE 702, or from the NE 702 to the UE 704.

At 710, the process flow 700 includes the UE 704 sending to the NE 702, and the NE 702 receiving, an SDT termination request. The SDT termination request may be an RRC level UE assistance information (UAI) request message or a medium access control control element (MAC CE) based request. This request is initiated by the UE 704 and may be based on the end of the data transfer at 708, e.g., end of the SDT.

At 712, the process flow 700 includes the NE 702 sending and the UE 704 receiving an SDT termination command which ends the SDT session. In some aspects, the SDT termination command is in response to the SDT termination request at 710. In some aspects, the SDT termination command corresponds to a RRC release command with suspend configuration that causes the UE 704 to perform an RRC suspend operation that may correspond to the RRC suspend 505 of FIG. 5 or the RRC suspend 605 of FIG. 6.

At 714, the UE 704 ends the SDT session, and enters a DRX cycle in RRC inactive state. For example, the DRX cycle may be an inactive state DRX cycle. The DRX cycle may correspond to the DRX cycle 510a or 510b of FIG. 5 or the DRX cycle 610 of FIG. 6. Therefore, in some aspects, the process flow 700 optimizes the power of an SDT session due to the UE 704 exiting the SDT session early via the SDT termination request initiated by the UE 704. The UE 704 may initiate this request based on the end of the SDT.

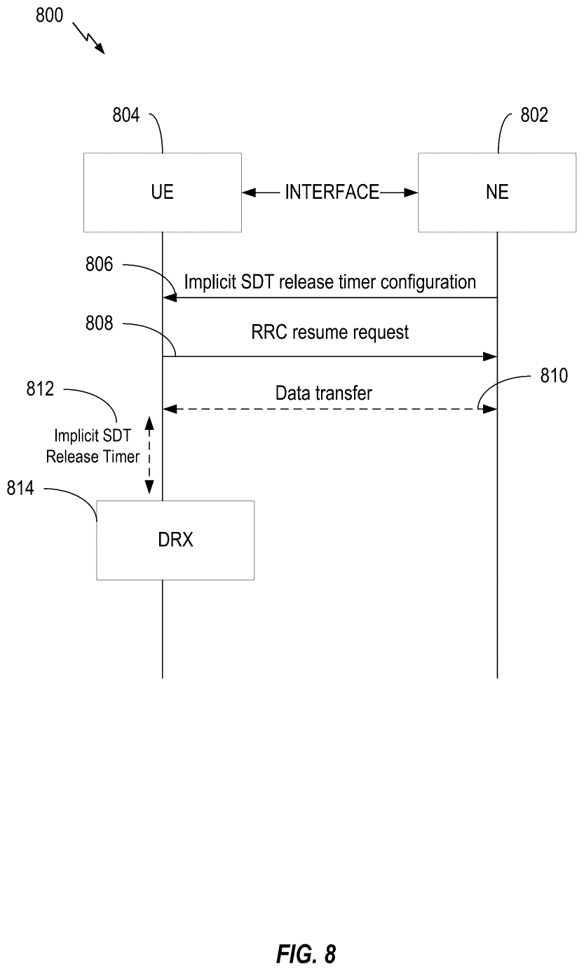

FIG. 8 depicts a process flow 800 for communications in a wireless communications network between a UE 804 and an NE 802 for power optimized SDT. The process flow 800 may include various blocks 806-812.

In some aspects, a network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, the UE 804 may be another type of wireless communications device and NE may be another type of network entity or network node, such as those described herein.

In some aspects, the process flow 800 includes at 806 the NE 802 sending, and the UE 804 receiving, an indication of an implicit SDT release timer 812 configuration. The implicit SDT release timer 812 does not rely on explicit signaling from the NE 802 to commence or be activated, and may be based on the UE 804's status. For example the SDT release timer configuration may be activated upon an end of known SDTs in an SDT session. For example, the SDT release timer may correspond to the SDT release timers 506a or 506b of FIG. 5, or the SDT release timer 606 of FIG. 6, or may be a variation thereof. The SDT release timer configuration may be sent via a system information block (SIB) (e.g., broadcast to multiple UEs including the UE 804), or an RRC signal that is specific to the UE 804.

In some aspects, the process flow 800 includes the UE 804 sending and the NE 802 receiving an RRC resume request at 808. Based on the RRC resume request, the UE 804 may enter an RRC resume operation that corresponds to the RRC resume 502a or the RRC resume 502b of FIG. 5 or the RRC resume 602 of FIG. 6. For example, the UE 804 may establish a connection between itself and the NE 802, whereupon the UE 804 enters an SDT session that may correspond to the SDT sessions 509a or 509b of FIG. 5, or the SDT session 609 of FIG. 6.

The process flow 800 then includes data transfer at 810 between the UE 804 and the NE 802. The data transfer at 810 may be an SDT, and may correspond to SDTs 503a or 503b of FIG. 5, or SDT 603 of FIG. 6. The data transfer at 810 may be from the UE 804 to the NE 802, or from the NE 802 to the UE 804. In some aspects, the end of the data transfer at 810 may cause the UE 804 to trigger the implicit SDT release timer 812.

At 814, the UE 704 ends the SDT session and enters a DRX cycle in RRC inactive state. This may be done based on expiry of the implicit SDT release timer 812. The implicit SDT release timer 812 may be activated or expire without additional signaling to the NE 802. The DRX cycle may correspond to the DRX cycle 510a or 510b of FIG. 5 or the DRX cycle 610 of FIG. 6. In some aspects, the process flow 800 therefore optimizes the power of an SDT session by exiting the SDT session early via changing the UE's internal state to DRX cycle upon the expiry of the implicit SDT release timer. In some aspects, where the NE 802 has spillover small data, it can initiate the process flow 800 and send the implicit SDT timer to trigger the UE 804 to perform SDT. “Spillover small data” may refer to small data packets yet to be transmitted and associated with data that was already successfully transmitted.

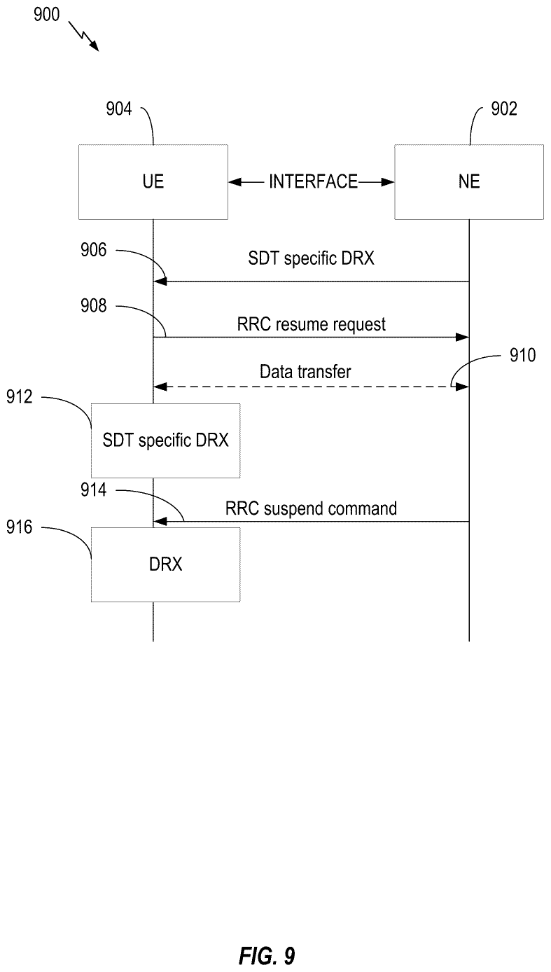

FIG. 9 depicts a process flow 900 for communications in a network between a UE and NE for power optimized SDT.

In some aspects, a network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, the UE 904 may be another type of wireless communications device and NE may be another type of network entity or network node, such as those described herein.

In some aspects, the process flow 900 begins at 906, with the NE 902 sending and the UE 904 receiving, an indication of an SDT-specific DRX cycle. The indication of the SDT-specific DRX cycle may be sent/received via SIB or RRC. For example, the SDT-specific DRX cycle may configure the UE 804 to enter a DRX cycle upon completion of SDT and during an SDT session. An SDT session may correspond to the SDT sessions 509a or 509b of FIG. 5, or the SDT session 609 of FIG. 6.

The SDT-specific DRX may comprise a low power state (such as the low power state 608) during the SDT session where the UE 1004 may periodically switch from an idle mode to an active mode. In the idle mode, the UE may not monitor a PDCCH. In some aspects, the active mode allows the UE to engage in monitoring for, receiving, or decoding of PDCCH. In some aspects, similar to a DRX cycle for an RRC inactive state, the SDT-specific DRX cycle comprises idle modes that are longer in duration than subsequent active modes, to produce power efficiency gains. By comparison, a standby state (e.g., the standby states 504a or 504b of FIG. 5), where the UE 804 may continuously perform monitoring and PDCCH decoding, leads to power inefficiencies. For example, the SDT-specific DRX cycle may be a low power state (such as the low power state 608) with periodic instances of PDCCH monitoring or decoding.

In some aspects, the UE 904 may only enter the SDT-specific DRX cycle if the UE does not have any uplink data left (for UE 904 initiated SDTs), or is no longer receiving a grant of UL resources from the NE 902 (for the NE 902 initiated/UE 904 terminated SDT) for a specific duration. The specific duration may correspond to (e.g., be defined by) the SDT release timers 506a or 506b of the FIG. 5, or the SDT release timer 606 of FIG. 6.

In some aspects, the process flow 900 includes the UE 904 sending and the NE 902 receiving an RRC resume request at 908. Based on the RRC resume request, the UE 904 may enter an RRC resume operation that corresponds to the RRC resume 502 of FIG. 5, or the RRC resume 602 of FIG. 6. SDT session 609 The UE 904 and the NE 902 may establish a connection and initiate an SDT session. The SDT session corresponds to the SDT session 509 of FIG. 5 or the SDT session 609 of FIG. 6.

The process flow 900 then includes data transfer at 910 between the UE 904 and the NE 902. The data transfer at 910 may be an SDT, and may correspond to SDT 503 of FIG. 5 or SDT 603 of FIG. 6. The data transfer at 910 may be from the UE 904 to the NE 902, or from the NE 902 to the UE 904.

In some aspects, at 912, the UE 904 enters the SDT-specific DRX cycle during the SDT session and subsequent to completion of the data transfer at 910 (e.g., completion of SDT). Entering the SDT-specific DRX cycle may be based on the indication of the SDT-specific DRX cycle received at 906. The SDT-specific DRX cycle may continue for a duration (configured by the UE 904 or the NE 902). For example, the duration of the SDT-specific DRX cycle may correspond to the SDT release timer duration 506 of FIG. 5, or the SDT release timer 606, or the low power duration 612 of FIG. 6. In some aspects, the indication of the SDT-specific DRX cycle may only trigger a UE to enter the SDT-specific DRX cycle if the UE does not have any uplink data left (for UE 904 initiated SDTs), or is no longer receiving a grant of UL resources from the NE 902 for a specific duration (for NE 902 initiated/UE 904 terminated SDT).

In some aspects, at 914, the NE 902 sends and the UE 904 receives an RRC release command with suspend configuration, which may cause the UE 904 to enter an RRC suspend operation (referred to as “RRC suspend”) and terminate the SDT session. The RRC suspend may correspond to the RRC suspend 505a or the RRC suspend 505b of FIG. 5, or the RRC suspend 605 of FIG. 6.

At 916, the UE 904 ends the SDT session and changes its local state to enter into DRX cycle in RRC inactive state based on the receipt at 914 of the RRC release command. In some aspects, during at least a portion of the DRX cycle, the UE may enter a sleep mode. The DRX cycle may correspond to the DRX cycles 510a or 510b of FIG. 5 or the DRX cycle 610 of FIG. 6.

In some aspects, the process flow 900 therefore optimizes the power of an SDT session by entering a low power state that is an SDT-specific DRX cycle instead of entering a standby state such as standby states 504a or 504b of FIG. 5. In the idle mode of the SDT-specific DRX cycle, the UE avoids PDCCH decoding or monitoring and may enter a low power state instead of being in an active standby state. In situations where the NE 902 has spillover small data, it can initiate the process flow 900 and send the indication of SDT-specific DRX cycle at 906, which is received by the UE 904, to trigger the UE 904 to perform SDT.

The various blocks of the process flows 700-900 of FIGS. 7-9 may be combined in any order and with any combination of blocks of process flows 700-900 of FIGS. 7-9. As just one example, one or more blocks of process flow 700 may be implemented in process flow 800 and/or process flow 900.

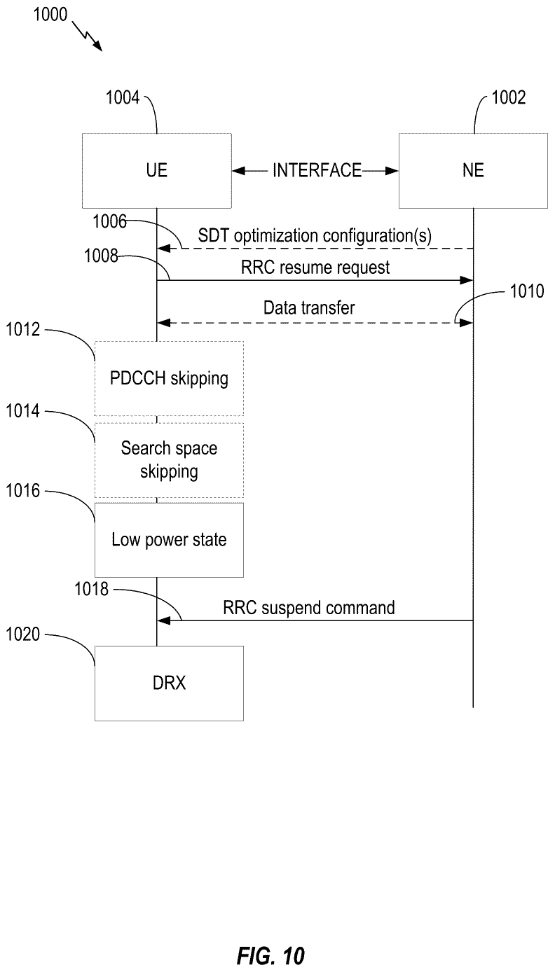

FIG. 10 depicts a process flow 1000 for communications in a wireless communications network between a UE 1004 and an NE 1002 for power optimized SDT.

In some aspects, a network entity 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, the UE 1004 may be another type of wireless communications device and NE may be another type of network entity or network node, such as those described herein.

In some aspects, the process flow 1000 optionally includes, at 1006, the NE 1002 sending and the UE 1004 receiving indications of SDT optimization configuration(s). The indications of SDT optimization configuration(s), may be received via SIB or RRC. In some aspects, the indications of SDT optimization configuration(s) may include a PDCCH skipping pattern configured by the NE 1002. For example, the PDCCH skipping pattern may be sent at 1006 via broadcast in SIB. It may also be sent through UE specific signaling in a suspend configuration via RRC signaling.

In some aspects, the indications of SDT optimization configuration(s) may comprise a configuration of one or more SDT search spaces. For example, the NE 1002 may configure multiple search spaces, a regular search space (e.g., SDT-searchspaceregular) and a sparse search space (SDT-searchspacesparse). A search space refers to an area in the downlink resource grid where PDCCH may be carried. The UE may perform blind decoding in the search space trying to find PDCCH data. The sparse search space may be associated with a lower search space density than the regular search space. “Search space density” may refer to any one or more of a number of slots included in a search space, a number of symbols within a slot of the search space, or a number of PDCCH candidates within a search space, among other examples (e.g., a number or size of aggregation levels, etc.). For example, the sparse search space may include fewer PDCCH candidates than the regular search space.

In some aspects, the process flow 1000 includes the UE 1004 sending and the NE 1002 receiving an RRC resume request at 1008. Based on the RRC resume request, the UE 1004 may enter into an RRC resume operation that corresponds to the RRC resume 502a or the RRC resume 502b of FIG. 5, or the RRC resume 602 of FIG. 6. Thus, the process flow 1000 may establish a connection between the UE 1004 and the NE 1002, and may initiate an SDT session, which may correspond to the SDT sessions 509a or 509b of FIG. 5 or the SDT session 609 of FIG. 6.

The process flow 1000 then includes data transfer at 1010 between the UE 1004 and the NE 1002. The data transfer at 1010 may be an SDT, and may correspond to SDTs 503a or 503b of FIG. 5, or SDT 603 of FIG. 6. The data transfer at 1010 may be from the UE 1004 to the NE 1002, or from the NE 1002 to the UE 1004.

In optional aspects, when the indications of SDT optimization configuration(s) include a PDCCH skipping pattern, at 1012 the UE 1004 may enter a low power state according to a PDCCH skipping pattern that was provided in the indications of SDT optimization configuration(s). The PDCCH skipping pattern causes the UE 1004 to skip PDCCH decoding in slot(s) to reduce power consumption at least during the skipped slot(s). Therefore PDCCH skipping pattern may correspond to the low power state 608 of FIG. 6.

For example, a PDCCH skipping pattern may comprise a number of low power state slot(s) (x), followed by a number of monitoring slot(s) (y) where the UE monitors, receives, and decodes PDCCH. The UE may skip PDCCH monitoring in the number of low power state slots, and may monitor PDCCH in the number of monitoring slots. In some aspects, the PDCCH skipping pattern may indicate a pattern of low power state slots and monitoring slots, such as a periodic pattern.

In some aspects, PDCCH skipping at 1012 may be triggered implicitly or explicitly. Explicit triggering of PDCCH skipping may occur through network signaling via DCI to activate or deactivate PDCCH skipping. For example, fallback DCI and an SDT-specific search space may be used during the SDT session. As another example, additional bits may be used in. fallback DCI to introduce different skipped slots within the SDT-specific search space. Fallback DCI (Downlink Control Information) refers to a mechanism designed to handle situations where the UE falls back from a higher-level downlink control channel to a lower-level downlink control channel. Implicit PDCCH skipping may occur if the UE 1004 does not have any uplink data left to send (for UE 1004 initiated SDT), or is no longer receiving a grant of UL resources from the NE 1002 for a specific duration (for NE 1002 initiated/UE 1004 terminated SDT).

In some aspects, subsequent to the data transfer at 1010, when the indications of SDT optimization configuration(s) include SDT search space configuration(s), the UE 1004 may switch between search spaces configured by the NE 1002. A search space includes a set of candidate slots for monitoring or decoding, e.g., during a standby state that may correspond to the standby states 504a or 504b of FIG. 5, or the standby states 604a or 604b of FIG. 6.

In some optional aspects, SDT search space configuration(s) comprise a regular search space and a sparse search space. For example the regular search space may have the UE 1004 monitoring or decoding every slot or every second slot. The sparse search space may have the UE 1004 monitor or decode every one out of eight or one out of sixteen slots. Therefore, the sparse search space has a fewer numbers of slots configured to be monitored or decoded for PDCCH by the UE 1004 than the regular search space. The sparse search space therefore has a lower density than the density of the regular search space. In the sparse search space, the UE 1004 enters a low power state (e.g., that may correspond to the low power state 608 of FIG. 6).

In some aspects, skipping slots in a search space may be based on a periodical pattern or based on a number of monitored or decoded slots per total number of slots. For example, a search space may be configured for the UE 1004 to monitor every fifth slot. Because the sparse search space has a lower density than the regular search space, it provides more opportunities for the UE 1004 to enter a low power state at 1014. The low power state may correspond to the low power state 608 of FIG. 6.

In some optional aspects, search space switching (e.g., switching from a regular search space regular to a sparse search space) may be triggered implicitly or explicitly. Search space switching involves switching the UE 1004 from one configured search space to another configured search space. Explicit triggering of search space switching may occur through network signaling, e.g., via UE-specific signaling such as DCI, or an RRC release command. The search space switching may also be triggered in a broadcast manner, e.g., via SIB. Implicit search space switching (e.g., initiated by the UE 1004 without explicit signals from the NE 1002) may occur if the UE 1004 does not have any uplink data left to send (for UE 1004 initiated SDT), or is no longer receiving a grant of UL resources from the NE 1002 for a specific duration (for NE 1002 initiated/UE 904 terminated SDT). This specific duration may be predefined by the SDT search space configuration(s).

In some aspects, at 1016 the UE 1004 may enter into a low power state without additional signaling to the NE 1002. In some aspects, during the low power state the UE 1004 may enter a sleep mode. In some aspects, during the low power state the UE 1004 does not engage in PDCCH decoding or monitoring of signals. In some aspects, the low power state may correspond to the low power state 608 of FIG. 6. It should be noted that the PDCCH skipping at 1012 and/or the search space switching at 1014 may be examples of the low power state at 1016.

In some aspects, at 1018, the NE 1002 sends and the UE 1004 receives an RRC release command, which may cause the UE to enter an RRC suspend operation (RRC suspend) and terminate the SDT session. The RRC suspend may correspond to the RRC suspend 505 of FIG. 5, or the RRC suspend 605 of FIG. 6.

At 1020, the UE 1004 may enter into a DRX cycle in RRC inactive state based on the receipt at 1018 of the RRC release command. In some aspects, during at least a portion of the DRX cycle, the UE may enter an off-duration mode in the DRX cycle. The DRX cycle may correspond to the DRX cycle 510a or 510b of FIG. 5, or the DRX cycle 610 of FIG. 6. The DRX cycle at 1020 may occur within the RRC inactive state or RRC idle state.

### Example Operations of a User Equipment

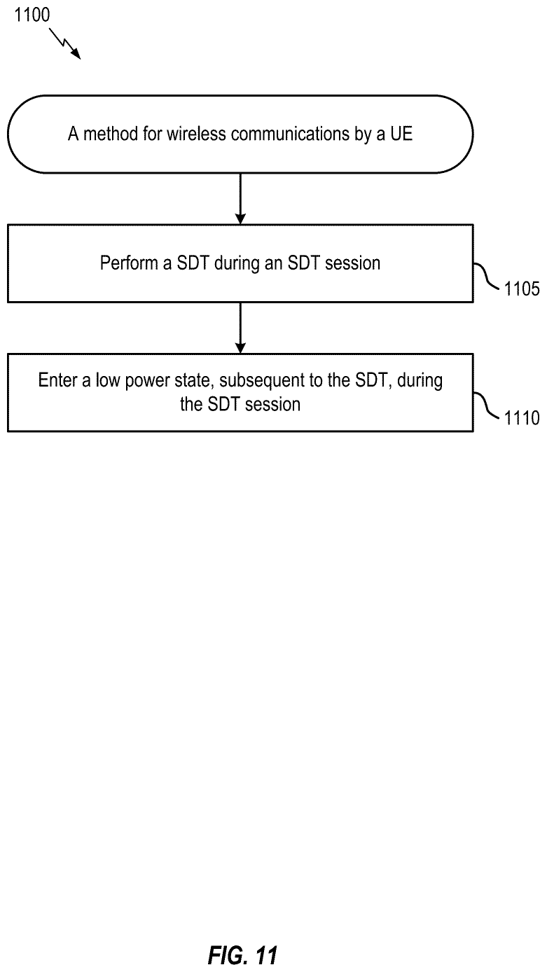

FIG. 11 shows a method 1100 for wireless communications by an apparatus, such as UE 104 of FIG. 1 or UE 304 of FIG. 3.

Method 1100 begins at block 1105 with performing a SDT during an SDT session. For example, block 1105 may correspond to data transfer 1010 of FIG. 10.

Method 1100 then proceeds to block 1110 with entering a low power state, subsequent to the SDT, during the SDT session. For example, block 1110 may correspond to block 1016 of FIG. 10. Entering a low power state during the SDT session reduces power consumption by the UE during the SDT session.

In some aspects, block 1110 includes entering the low power state in association with a completion of the SDT, for a duration.

In some aspects, a length of the duration is different than a length of an SDT release timer associated with the SDT.

In some aspects, the duration is associated with at least one of historical temporal data or a release timer associated with an NE.

In some aspects, the low power state comprises at least one of a sleep state, a state that prevents PDCCH monitoring or decoding, or an SDT-specific DRX cycle.

In some aspects, method 1100 further includes exiting the low power state in association with an end of a duration.

In some aspects, method 1100 further includes receiving an RRC suspend command to exit an SDT session.

In some aspects, method 1100 further includes exiting the SDT session in accordance with the RRC suspend command.

In some aspects, PDCCH decoding is suspended during the low power state.

In some aspects, method 1100 further includes receiving an indication of an SDT search space configuration.

In some aspects, method 1100 further includes monitoring a PDCCH in a slot according to the SDT search space configuration, wherein the slot falls outside of slots associated with the low power state.

In some aspects, the SDT search space configuration has a first search space configuration and wherein the first search space configuration is associated with a lower density than a second search space configuration.

In some aspects, while the UE is in the low power state, the UE is configured to use the SDT search space configuration.

In some aspects, method 1100 further includes receiving an indication of an SDT-specific DRX cycle release timer from an NE, wherein block 1110 includes entering the low power state associated with the SDT-specific DRX cycle release timer.

In some aspects, method 1100 further includes receiving an indication of a PDCCH skipping pattern configuration, wherein block 1110 includes entering the low power state in association with the PDCCH skipping pattern configuration.

In some aspects, the PDCCH skipping pattern configuration indicates one or more slots in which the UE is to skip decoding of a PDCCH, wherein the method 1100 further comprises skipping the decoding of the PDCCH in the one or more slots.

In some aspects, while the UE is in the low power state, the UE is configured to use the PDCCH skipping pattern configuration.

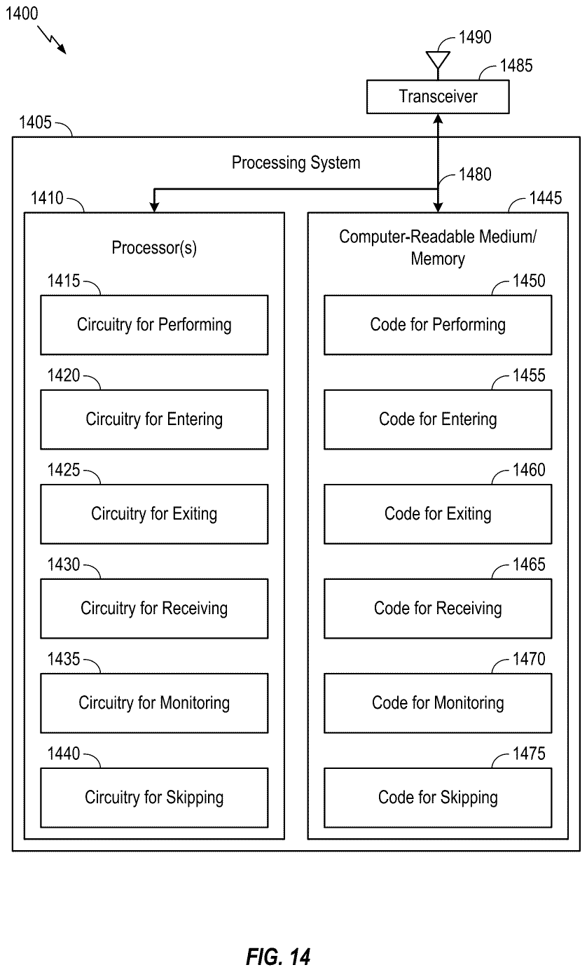

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative operations are possible consistent with this disclosure.

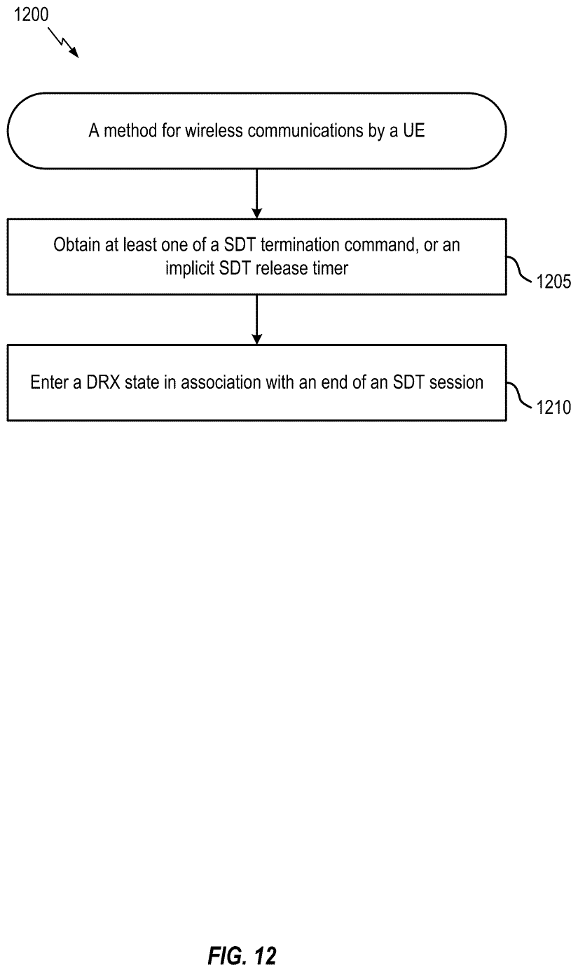

FIG. 12 shows a method 1200 for wireless communications by an apparatus, such as UE 104 of FIG. 1 or UE 304 of FIG. 3.

Method 1200 begins at block 1205 with obtaining at least one of a SDT termination command, or an implicit SDT release timer. For example, block 1205 may correspond to 712 of process flow 700 of FIG. 7, and 806 of process flow 800 of FIG. 8.

Method 1200 then proceeds to block 1210 with entering a DRX state in association with an end of an SDT session. For example, block 1210 may correspond to 714 of process flow 700 of FIGS. 7 and 814 of process flow 800 of FIG. 8. Entering a DRX earlier than a scheduled end of an SDT session reduces total power consumption of a UE while in an SDT session.

In some aspects, method 1200 further includes performing SDT during an SDT session.

In some aspects, method 1200 further includes sending a termination request during the SDT session, the termination request associated with a completion of the SDT.

In some aspects, method 1200 further includes ending the SDT session in association with an expiration of the implicit SDT release timer.

In some aspects, method 1200 further includes ending the SDT session in association with at least one of an exhaustion of uplink transmissions or not receiving granted uplink resources for a duration.

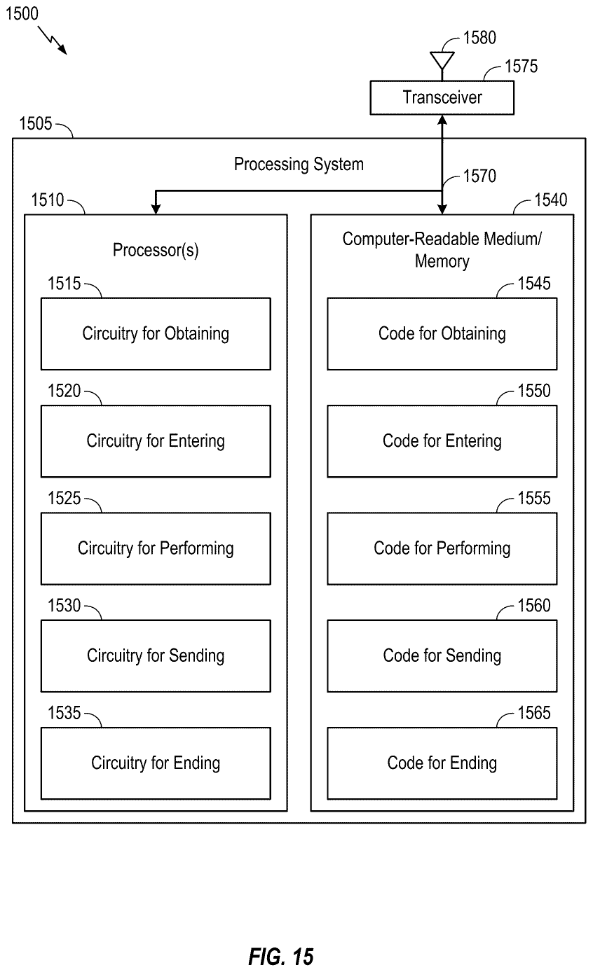

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative operations are possible consistent with this disclosure.

### Example Operations of a Network Entity

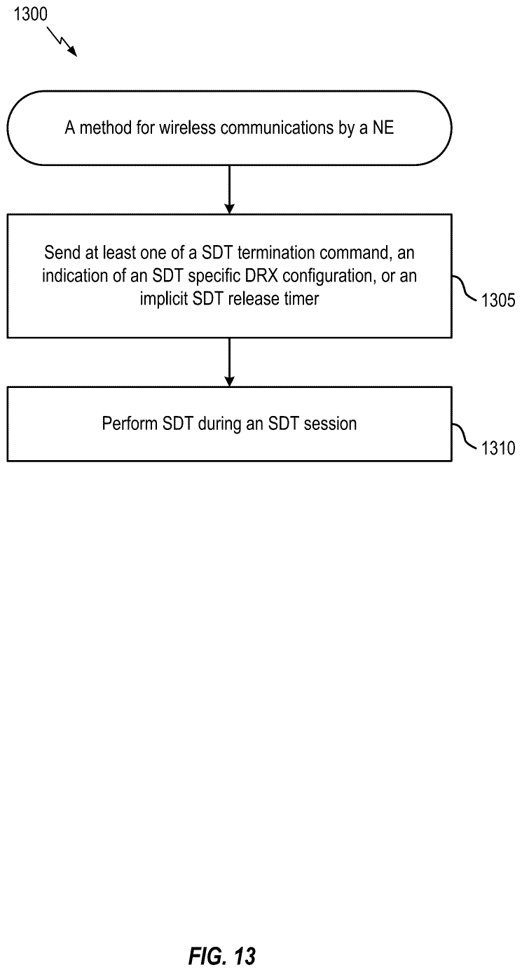

FIG. 13 shows a method 1300 for wireless communications by an apparatus, such as BS 102 of FIG. 1, a first network entity 300 or second network entity 302 of FIG. 3, or a disaggregated base station as discussed with respect to FIG. 2.

Method 1300 begins at block 1305 with sending at least one of a SDT termination command, an indication of an SDT-specific DRX cycle configuration, or an implicit SDT release timer. For example, the block 1305 may correspond to 712 of process flow 700 of FIG. 7, 806 of process flow 800 of FIG. 8, and 906 of process flow 900 of FIG. 9. Block 1305 provides the UE with the ability to end an SDT session to reduce power consumption in the SDT session.

Method 1300 then proceeds to block 1310 with performing SDT during an SDT session. For example, the block 1305 may correspond to 712 of process flow 708 of FIG. 7, 810 of process flow 800 of FIG. 8, and 910 of process flow 900 of FIG. 9.

Method 1300 further sending a command to end the SDT session.

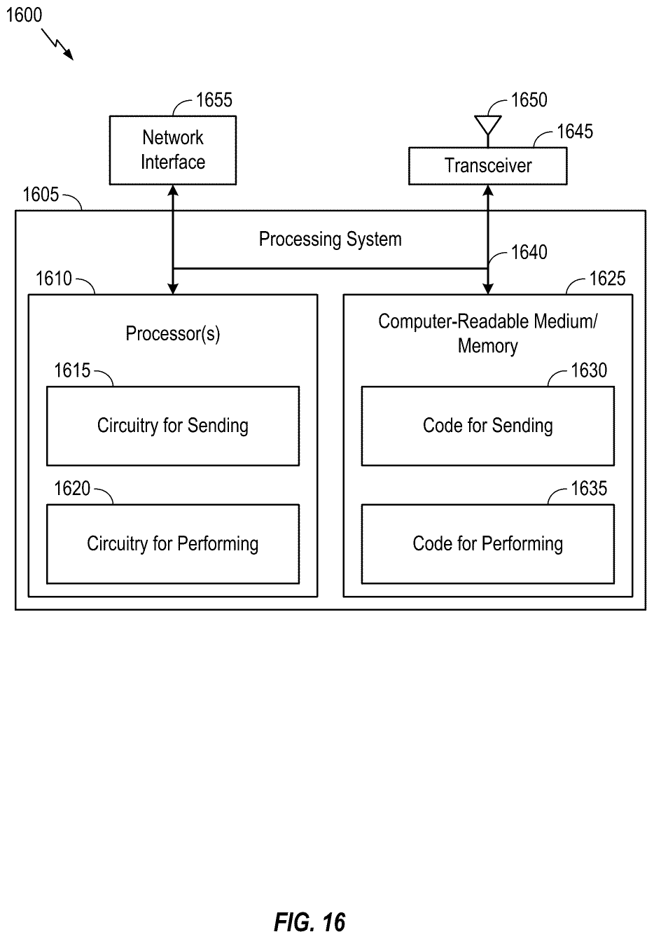

In one aspect, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1485 (e.g., a transmitter and/or a receiver). The transceiver 1485 is configured to transmit and receive signals for the communications device 1400 via an antenna 1490, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1445. In various aspects, the one or more processors 1410 may be representative of the one or more processors 318 described with respect to FIG. 3. The one or more processors 1410 are coupled to a computer-readable medium/memory 1445 via a bus 1480. In some aspects, the computer-readable medium/memory 1445 may be representative of the one or more memories 320 described with respect to FIG. 3. The computer-readable medium/memory 1445 is a non-transitory computer-readable medium/memory. In certain aspects, the computer-readable medium/memory 1445 is configured to store instructions (e.g., computer-executable code), that when executed by the one or more processors 1410, cause the one or more processors 1410 to perform the method 1100 described with respect to FIG. 11, or any aspect related to it, including any operations described in relation to FIG. 11. Note that reference to a processor performing a function of communications device 1400 may include one or more processors performing that function of communications device 1400, such as in a distributed fashion.

In the depicted example, computer-readable medium/memory 1445 stores code (e.g., executable instructions), including code for performing 1450, code for entering 1455, code for exiting 1460, code for receiving 1465, code for monitoring 1470, and code for skipping 1475. Processing of the code 1450-1475 may enable and cause the communications device 1400 to perform the method 1100 described with respect to FIG. 11, or any aspect related to it.

The one or more processors 1410 include circuitry configured to implement (e.g., execute) the code stored in the computer-readable medium/memory 1445, including circuitry for performing 1415, circuitry for entering 1420, circuitry for exiting 1425, circuitry for receiving 1430, circuitry for monitoring 1435, and circuitry for skipping 1440. Processing with circuitry 1415-1440 may enable and cause the communications device 1400 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1485 and/or antenna 1490 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1485 and/or antenna 1490 of the communications device 1400 in FIG. 14, and/or one or more processors 1410 of the communications device 1400 in FIG. 14.

FIG. 15 depicts aspects of an example communications device 1500 configured for wireless communications. In some aspects, communications device 1500 is a user equipment, such as UE 104 described above with respect to FIG. 1 or UE 304 described with respect to FIG. 3.

The communications device 1500 includes a processing system 1505 coupled to a transceiver 1575 (e.g., a transmitter and/or a receiver). The transceiver 1575 is configured to transmit and receive signals for the communications device 1500 via an antenna 1580, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1540. In various aspects, the one or more processors 1510 may be representative of the one or more processors 318 described with respect to FIG. 3. The one or more processors 1510 are coupled to a computer-readable medium/memory 1540 via a bus 1570. In some aspects, the computer-readable medium/memory 1540 may be representative of the one or more memories 320 described with respect to FIG. 3. The computer-readable medium/memory 1540 is a non-transitory computer-readable medium/memory. In certain aspects, the computer-readable medium/memory 1540 is configured to store instructions (e.g., computer-executable code), that when executed by the one or more processors 1510, cause the one or more processors 1510 to perform the method 1200 described with respect to FIG. 12, or any aspect related to it, including any operations described in relation to FIG. 12. Note that reference to a processor performing a function of communications device 1500 may include one or more processors performing that function of communications device 1500, such as in a distributed fashion.

In the depicted example, computer-readable medium/memory 1540 stores code (e.g., executable instructions), including code for obtaining 1545, code for entering 1550, code for performing 1555, code for sending 1560, and code for ending 1565. Processing of the code 1545-1565 may enable and cause the communications device 1500 to perform the method 1200 described with respect to FIG. 12, or any aspect related to it.

The one or more processors 1510 include circuitry configured to implement (e.g., execute) the code stored in the computer-readable medium/memory 1540, including circuitry for obtaining 1515, circuitry for entering 1520, circuitry for performing 1525, circuitry for sending 1530, and circuitry for ending 1535. Processing with circuitry 1515-1535 may enable and cause the communications device 1500 to perform the method 1200 described with respect to FIG. 12, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1575 and/or antenna 1580 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1575 and/or antenna 1580 of the communications device 1500 in FIG. 15, and/or one or more processors 1510 of the communications device 1500 in FIG. 15.

FIG. 16 depicts aspects of an example communications device configured for wireless communications. In some aspects, communications device 1600 is a network entity, such as BS 102 of FIG. 1, first network entity 300 or second network entity 302 of FIG. 3, or a disaggregated base station as discussed with respect to FIG. 2.

The communications device 1600 includes a processing system 1605 coupled to a transceiver 1645 (e.g., a transmitter and/or a receiver) and/or a network interface 1655. The transceiver 1645 is configured to transmit and receive signals for the communications device 1600 via an antenna 1650, such as the various signals as described herein. The network interface 1655 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610 and a computer-readable medium/memory 1625. In various aspects, one or more processors 1610 may be representative of the one or more processors 308, as described with respect to FIG. 3. The one or more processors 1610 are coupled to the computer-readable medium/memory 1625 via a bus 1640. In certain aspects, the computer-readable medium/memory 1625 is configured to store instructions (e.g., computer-executable code), including code 1630 and 1635, that when executed by the one or more processors 1610, cause the one or more processors 1610 to perform the method 1300 described with respect to FIG. 13, or any aspect related to it, including any operations described in relation to FIG. 13. The computer-readable medium/memory 1625 is a non-transitory computer-readable medium/memory. Note that reference to a processor of communications device 1600 performing a function may include one or more processors of communications device 1600 performing that function, such as in a distributed fashion.

In the depicted example, the computer-readable medium/memory 1625 stores code (e.g., executable instructions), including code for sending 1630 and code for performing 1635. Processing of the code 1630 and 1635 may enable and cause the communications device 1600 to perform the method 1300 described with respect to FIG. 13, or any aspect related to it.

The one or more processors 1610 include circuitry configured to implement (e.g., execute) the code stored in the computer-readable medium/memory 1625, including circuitry for sending 1615 and circuitry for performing 1620. Processing with circuitry 1615 and 1620 may enable and cause the communications device 1600 to perform the method 1300 described with respect to FIG. 13, or any aspect related to it.

Various components of the communications device 1600 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1645, antenna 1650, and/or network interface 1655 of the communications device 1600 in FIG. 16, and/or one or more processors 1610 of the communications device 1600 in FIG. 16. Means for communicating, receiving or obtaining may include the one or more transceivers 312, one or more antennas 314, and/or processing system 306 of the first network entity 300 or the second network entity 302 illustrated in FIG. 3, transceiver 1645, antenna 1650, and/or network interface 1655 of the communications device 1600 in FIG. 16, and/or one or more processors 1610 of the communications device 1600 in FIG. 16. For example, means for sending at 1305 performing at 1310 of the method 1300 described with respect to FIG. 13, or any aspect related to it.

### Example Clauses

Implementation examples are described in the following numbered clauses:

Clause 1: A method for wireless communications by a UE comprising: performing a SDT during an SDT session; and entering a low power state, subsequent to the SDT, during the SDT session.

Clause 2: The method of Clause 1, wherein entering the low power state comprises entering the low power state in association with a completion of the SDT, for a duration.

Clause 3: The method of Clause 2, wherein a length of the duration is different than a length of an SDT release timer associated with the SDT.

Clause 4: The method of Clause 2, wherein the duration is associated with at least one of historical temporal data or a release timer associated with an NE.

Clause 5: The method of any one of Clauses 1-4, wherein the low power state comprises at least one of a sleep state, a state that prevents PDCCH monitoring or decoding, or an SDT-specific DRX cycle state.

Clause 6: The method of any one of Clauses 1-5, further comprising: exiting the low power state in association with an end of a duration.

Clause 7: The method of any one of Clauses 1-6, further comprising: receiving an RRC release command to exit an SDT session; and exiting the SDT session in accordance with the RRC release command.

Clause 8: The method of any one of Clauses 1-7, wherein PDCCH decoding is suspended during the low power state.

Clause 9: The method of any one of Clauses 1-8, further comprising: receiving an indication of an SDT search space configuration; and monitoring a PDCCH in a slot according to the SDT search space configuration, wherein the slot falls outside of slots associated with the low power state.

Clause 10: The method of Clause 9, wherein the SDT search space configuration has a first search space configuration and wherein the first search space configuration is associated with a lower density than a second search space configuration.

Clause 11: The method of Clause 9, wherein, while the UE is in the low power state, the UE is configured to use the SDT search space configuration.

Clause 12: The method of any one of Clauses 1-11, further comprising: receiving an indication of an SDT-specific DRX cycle release timer from an NE, wherein entering the low power state comprises entering the low power state associated with the SDT-specific DRX cycle release timer.

Clause 13: The method of any one of Clauses 1-12, further comprising: receiving an indication of a PDCCH skipping pattern configuration, wherein entering the low power state comprises entering the low power state in association with the PDCCH skipping pattern configuration.

Clause 14: The method of Clause 13, wherein the PDCCH skipping pattern configuration indicates one or more slots in which the UE is to skip decoding of a PDCCH, wherein the method further comprises skipping the decoding of the PDCCH in the one or more slots.

Clause 15: The method of Clause 13, wherein, while the UE is in the low power state, the UE is configured to use the PDCCH skipping pattern configuration.

Clause 16: A method for wireless communications by a UE comprising: obtaining at least one of a SDT termination command, or an implicit SDT release timer; and entering a DRX state in association with an end of an SDT session.

Clause 17: The method of Clause 16, further comprising: performing SDT during an SDT session; and sending a termination request during the SDT session, the termination request associated with a completion of the SDT.

Clause 18: The method of any one of Clauses 16-17, further comprising: ending the SDT session in association with an expiration of the implicit SDT release timer.

Clause 19: The method of any one of Clauses 16-18, further comprising: ending the SDT session in association with at least one of an exhaustion of uplink transmissions or not receiving granted uplink resources for a duration.

Clause 20: A method for wireless communications by a UE comprising: sending at least one of a SDT termination command, an indication of an SDT-specific DRX cycle, or an implicit SDT release timer; and performing SDT during an SDT session.

Clause 21: A method for wireless communications by a UE comprising: obtaining at least one of a small data transmission (SDT) termination command, or an implicit SDT release timer; and entering a discontinuous reception (DRX) state in association with an end of an SDT session.

Clause 22: The method of Clause 21 further comprising: performing SDT during an SDT session; and sending a termination request during the SDT session, to obtain the SDT termination command, the termination request associated with a completion of the SDT.

Clause 23: The method of any of Clauses 21-22 further comprising: ending the SDT session in association with an expiration of the implicit SDT release timer.

Clause 24: The method of any of Clauses 21-23 further comprising: ending the SDT session in association with at least one of an exhaustion of uplink transmissions or not receiving granted uplink resources for a duration.

Clause 25: A method for wireless communications by a NE comprising: sending at least one of a small data transmission (SDT) termination command, an indication of an SDT-specific discontinuous reception (DRX) cycle, or an implicit SDT release timer; and performing SDT during an SDT session in accordance with at least one of the SDT termination command, the indication, or the implicit SDT release timer.

Clause 26: One or more apparatuses, comprising: one or more memories comprising executable instructions; and one or more processors configured to execute the executable instructions and cause the one or more apparatuses to perform a method in accordance with any one of Clauses 1-25.

Clause 27: One or more apparatuses configured for wireless communications, comprising: one or more memories; and one or more processors, coupled to the one or more memories, configured to cause the one or more apparatuses to perform a method in accordance with any one of Clauses 1-25.

Clause 28: One or more apparatuses configured for wireless communications, comprising: one or more memories; and one or more processors, coupled to the one or more memories, configured to perform a method in accordance with any one of Clauses 1-25.

Clause 29: One or more apparatuses, comprising means for performing a method in accordance with any one of Clauses 1-25.

Clause 30: One or more non-transitory computer-readable media comprising executable instructions that, when executed by one or more processors of one or more apparatuses, cause the one or more apparatuses to perform a method in accordance with any one of Clauses 1-25.

Clause 31: One or more computer program products embodied on one or more computer-readable storage media comprising code for performing a method in accordance with any one of Clauses 1-25.

Clause 32: One or more apparatuses configured for wireless communications, comprising: a processing system that includes one or more processors and one or more memories coupled with the one or more processors, the processing system configured to cause the one or more apparatuses to perform a method in accordance with any one of Clauses 1-25.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communication, comprising a processing system that includes one or more processors, and one or more memories coupled with the one or more processors, the processing system configured to cause a user equipment (UE) to:
obtain an indication of at least one of a small data transmission (SDT) termination command, or an implicit SDT release timer; and
enter a discontinuous reception (DRX) state in association with an end of an SDT session, wherein the end of the SDT session is based on the SDT termination command or expiry of the implicit SDT release timer.

2. The apparatus of claim 1, wherein the processing system is further configured to cause the UE to:
end the SDT session in association with the expiry of the implicit SDT release timer or a receipt of the SDT termination command.

3. The apparatus of claim 1, wherein the processing system is further configured to cause the UE to:
perform SDT during the SDT session.

4. The apparatus of claim 1, wherein the SDT session comprises an SDT and a low power state.

5. The apparatus of claim 1, wherein the indication is of the SDT termination command, and the processing system is further configured to cause the UE to:
send a termination request, during the SDT session, to obtain the SDT termination command, the termination request associated with a completion of an SDT.

6. The apparatus of claim 5, wherein the processing system is further configured to cause the UE to:
obtain the SDT termination command in response to the termination request.

7. The apparatus of claim 6, wherein the processing system is further configured to cause the UE to:
end the SDT session in association with a receipt of the SDT termination command.

8. The apparatus of claim 5, wherein the SDT termination request is a radio resource control (RRC) level UE assistance information (UAI) request message or a medium access control control element (MAC CE) based request.

9. The apparatus of claim 1, wherein the implicit SDT release timer is configured to activate or expire without additional signaling from a network entity.

10. The apparatus of claim 1, wherein the processing system is further configured to cause the UE to:
send an RRC resume request to initiate the SDT session; and
initiate the SDT session in accordance with the RRC resume request.

11. The apparatus of claim 1, wherein the indication is obtained via a system information block (SIB) or a radio resource control (RRC) signal specific to the UE.

12. A method for wireless communication by a user equipment (UE), comprising:
obtaining an indication of at least one of a small data transmission (SDT) termination command, or an implicit SDT release timer; and
entering a discontinuous reception (DRX) state in association with an end of an SDT session, wherein the end of the SDT session is based on the SDT termination command or the implicit SDT release timer.

13. The method of claim 12, further comprising:
ending the SDT session in association with an expiration of the implicit SDT release timer or a receipt of the SDT termination command.

14. The method of claim 12, wherein the SDT session comprises an SDT and a low power state.

15. The method of claim 12, wherein the implicit SDT release timer is configured to activate or expire independent of additional signaling from a network entity.

16. The method of claim 12, further comprising:
sending a termination request during the SDT session, to obtain an SDT termination command, the termination request associated with a completion of an SDT.

17. The method of claim 16, further comprising:
obtaining the SDT termination command in response to the termination request; and
ending the SDT session in association with the SDT termination command.

18. The method of claim 12, further comprising:
sending an RRC resume request to initiate the SDT session; and
initiating the SDT session in accordance with the RRC resume request.

19. The method of claim 12, further comprising:
performing SDT during the SDT session.

20. One or more non-transitory computer-readable media comprising executable instructions that, when executed by one or more processors of an apparatus, cause the apparatus to perform operations comprising:
obtaining an indication of at least one of a small data transmission (SDT) termination command, or an implicit SDT release timer; and
entering a discontinuous reception (DRX) state in association with an end of an SDT session, wherein the end of the SDT session is based on the SDT termination command or the implicit SDT release timer.
